(19) United States
(12) Patent Application Publication
(10) Pub. No.: US 2023/0191168 A1
(43) Pub. Date: Jun. 22, 2023

(54) WEARABLE AIR PURIFIER

(71) Applicant: Dyson Technology Limited, Wiltshire (GB)

(72) Inventors: Duncan Jack PATTULLO, Bristol (GB); Stephen Andrew BAKER, Swindon (GB)

(73) Assignee: Dyson Technology Limited, Wiltshire (GB)

(21) Appl. No.: 17/923,438

(22) PCT Filed: Mar. 11, 2021
(86) PCT No.: PCT/GB2021/050603

§ 371 Date: Nov. 4, 2022

(30) Foreign Application Priority Data
May 18, 2020 (GB) 2007316.9

(51) Int. Cl. A62B 18/00; A62B 18/02; A62B 18/08; A62B 9/04; A62B 7/10

(52) U.S. Cl. CPC A62B 18/003; A62B 18/006; A62B 18/025; A62B 18/084; A62B 9/04; A62B 7/10

(57) ABSTRACT

A wearable air purifier includes a headgear, an air purifier assembly, and a nozzle assembly. The air purifier assembly includes a filter and an airflow generator for generating an airflow through the filter. The nozzle assembly includes an inlet aperture configured to receive a filtered airflow from the air purifier assembly, and an air outlet for emitting the filtered airflow from the nozzle assembly. The nozzle assembly includes a first end section connected to the headgear, a second end section connected to the headgear, and a midsection connected to the first end section by a first hinge and connected to the second end section by a second hinge.

### FIELD OF THE INVENTION

The present invention relates to a wearable air purifier, and a nozzle assembly for such a wearable air purifier.

### BACKGROUND OF THE INVENTION

Air pollution is an increasing problem and a variety of air pollutants have known or suspected harmful effects on human health. The adverse effects that can be caused by air pollution depend upon the pollutant type and concentration, and the length of exposure to the polluted air. For example, high air pollution levels can cause immediate health problems such as aggravated cardiovascular and respiratory illness, whereas long-term exposure to polluted air can have permanent health effects such as loss of lung capacity and decreased lung function, and the development of diseases such as asthma, bronchitis, emphysema, and possibly cancer.

In locations with particularly high levels of air pollution, many individuals have recognised the benefits of minimising their exposure to these pollutants and have therefore taken to wearing face masks with the aim of filtering out at least a portion of the pollutants present in the air before it reaches the mouth and nose. There have also been various attempts to develop air purifiers that can be worn by the user but that do not require the wearer's mouth and nose to be covered. For example, there are various designs for wearable air purifiers that are worn around the neck of the wearer and that create a jet of air that is directed upwards towards the wearer's mouth and nose. There is a general desire for wearable air purifiers to be comfortable for a wearer in use.

### SUMMARY OF THE INVENTION

According to a first aspect of the present invention there is provided a wearable air purifier comprising: a headgear; an air purifier assembly, the air purifier assembly comprising a filter and an airflow generator for generating an airflow through the filter; and a nozzle assembly comprising an inlet aperture configured to receive a filtered airflow from the air purifier assembly, and an air outlet for emitting the filtered airflow from the nozzle assembly; wherein the nozzle assembly comprises a first end section connected to the headgear, a second end section connected to the headgear, and a midsection connected to the first end section by a first hinge and connected to the second end section by a second hinge.

The wearable air purifier according to the first aspect of the present invention may be beneficial principally as the nozzle assembly comprises a first end section connected to the headgear, a second end section connected to the headgear, and a midsection connected to the first end section by a first hinge and connected to the second end section by a second hinge.

In particular, as the midsection is connected to the first end section by a first hinge, and the midsection is connected to the second end section by a second hinge, the midsection may be able to move relative to both the first and second ends, which may provide increased flexibility in the arrangement of the nozzle assembly, thereby allowing for increased wearer comfort, and an arrangement in which the nozzle assembly is located closely relative to a face of a wearer in use. Such movability may allow the nozzle assembly to be adapted for a face of an individual wearer, for example, to closely conform to a face of an individual wearer.

The first and second end sections may be connected to the headgear directly, for example with no intervening components therebetween, or may be connected to the headgear indirectly, for example with one or more intervening components therebetween. The first and second end sections may be connected to the air purifier assembly, for example to first and second portions of the air purifier assembly. The air purifier assembly may comprise a purifier assembly housing supported by the headgear, and the first and second end sections may be connected to the purifier assembly housing.

The air outlet of the nozzle assembly may comprise a final component of the wearable air purifier through which filtered airflow travels before being emitted from the wearable purifier towards a wearer. For example, there may be no components of the wearable air purifier downstream of the air outlet of the nozzle assembly through which filtered airflow passes in use, and filtered airflow may be emitted from the air outlet, and hence from the nozzle assembly, toward the mouth and nasal region of a wearer in use.

The first and second end sections may be fixedly connected to the headgear, or may be releasably connected to the headgear, for example such that the nozzle assembly is releasable and at least partially separable from the headgear. A releasable connection may facilitate cleaning of the nozzle assembly.

The first end section may be connected to a first side of the headgear, and the second end section may be connected to a second side of the headgear, the second side opposite to the first side. The first side of the headgear may be opposite to the second side of the headgear, for example diametrically opposite, when the head wearable air purifier is located on a head of a wearer in use. The nozzle assembly may be configured such that, in use, with the headgear located on a head of a wearer, the nozzle assembly extends in front of a face of the wearer, for example such that the air outlet is located in a region of a mouth and/or lower nasal region of the wearer. The nozzle assembly may be configured such that, in use, the nozzle assembly extends in front of a face of the wearer without contacting the face of the wearer. This may provide an arrangement with increased comfort for the wearer, for example relative to an arrangement where the nozzle assembly contacts a face of a wearer in use. The nozzle assembly may be generally elongate and arcuate in form. The air outlet may be substantially centrally located along the nozzle assembly, for example located centrally upon the midsection.

The first and second hinges may allow rotation of the midsection relative to the respective first and second end sections in a plane substantially parallel to a transverse plane of a wearer of the headgear in use, for example a plane substantially orthogonal to a coronal plane of the wearer and substantially orthogonal to a sagittal plane of a wearer. The first and second hinges may allow internal and external rotation of the midsection relative to a midline of the headgear, for example an axis which bisects the headgear and runs parallel to a longitudinal axis of a wearer.

The first end section and the midsection may each comprise a hollow body, for example a conduit portion, the first end section may define at least a portion of the inlet aperture of the nozzle assembly and the midsection may define at least a portion the air outlet of the nozzle assembly. For example, in use filtered airflow may enter the nozzle assembly through an inlet aperture formed in the first end section, flow through the first end section and the midsection toward the air outlet, and exit the nozzle assembly toward a wearer through the air outlet.

The second end section may comprise a hollow body, for example a conduit portion, and the second end section may define at least a portion of a further inlet aperture of the nozzle assembly.

For example, the nozzle assembly may comprise first and second inlet apertures, the first inlet aperture formed in the first end section, and the second inlet aperture formed in the second end section, each of the first and second inlet apertures configured to receive filtered airflow from the air purifier assembly. Each of the first and second end sections may be configured to received filtered airflow generated by the airflow generator, or alternatively the wearable air purifier may comprise a further airflow generator, the first end section configured to receive filtered airflow generated by the airflow generator, and the second end section configured to receive filtered airflow generated by the further airflow generator. The airflow generator and filter may be configured to provide filtered airflow to the first end section of the nozzle assembly in use. The air purifier assembly may comprise a further airflow generator and a further filter configured to provide a further filtered airflow to the second end section of the nozzle assembly in use.

At least one of the first and second hinges may be located outside of filtered airflow through the nozzle assembly in use. This may be beneficial in that a hinge located outside of filtered airflow may provide no flow obstruction, which may decrease turbulence of filtered airflow through the nozzle assembly in use compared to, for example, an arrangement where a hinge is located within filtered airflow. A moving portion of at least one of the first and second hinges may be located outside of filtered airflow through the nozzle assembly in use.

At least one of the first and second hinges may comprise a pin received within a barrel, and the barrel may comprise a slot through which filtered airflow passes in use. This may be beneficial in that a moving part of the hinge, i.e. the pin, is not exposed to filtered airflow through the nozzle assembly in use. This may reduce the risk of any remaining particulate matter in the filtered airflow, depending of course on the grade of filter material used for the filter, building up on the moving part of the hinge and inhibiting normal operation of the hinge. This may also provide a compact and integrated hinge arrangement that does not necessarily require an external seal as the air flow conduit passes through the hinge.

A duct, for example a flexible duct, may extend through the slot of the barrel, and filtered airflow may flow through the flexible duct in use. This may be beneficial as it may prevent contact of filtered airflow with edges of the slot in use, which may reduce turbulence in filtered airflow compared to, for example, an arrangement where filtered airflow contacts edges of the slot in use. This may also minimise leakage of filtered airflow around the hinge.

The nozzle assembly may comprise a first bellows portion extending between the first end section and the midsection, and a second bellows portion extending between the second end section and the midsection. This may be beneficial as the first and second bellows portions may enable slight changes in dimension, for example via extension and retraction, to account for motion of the mid-section relative to the first and second end sections about the first and second hinges, whilst minimising leakage of the filtered airflow passing through the end sections to the midsection in use. The first and second bellows portions may each comprise a relatively flexible material.

The nozzle assembly may comprise at least one extension mechanism for increasing a length of the nozzle assembly. For example, the midsection and/or at least one of the first and second end sections may comprise an extension mechanism for increasing a length of the nozzle assembly. This may allow for further adjustment of the nozzle assembly by a wearer, which may allow for comfort of the wearer, and may ensure that the nozzle assembly closely conforms to a face of the wearer. The extension mechanism may comprise a telescoping or ratchet mechanism. In embodiments where the midsection comprises at least one extension mechanism, the extension mechanism may connect to the first or second hinge, for example.

The midsection may comprise at least one crease or ridge about which portions of the midsection, for example portions of the midsection either side of the crease, can flex relative to one another in use. This may enable greater flexibility of the midsection relative to, for example, a midsection formed of the same material absent the crease, and may allow for greater conformability of the nozzle assembly and increased wearer comfort.

The first end section may be at least partially connected to the headgear by a third hinge, and the second end section may be at least partially connected to the headgear by a fourth hinge. This may allow the first and second end sections to rotate relative to the headgear, which may enable greater flexibility in positioning of the nozzle assembly relative to a fixed arrangement. This may provide comfort for a wearer in use. The third and fourth hinges may allow rotation in a plane different to the plane of rotation enabled by the first and second hinges. For example, the third and fourth hinges may allow for rotation in a plane substantially parallel to a sagittal plane of a wearer in use. Thus the first and second hinges may enable rotation of the midsection in a left-right direction of a wearer in use, whilst the third and fourth hinges may enable rotation of the nozzle assembly in an up-down direction of the wearer in use.

The nozzle assembly may comprise a flow guide for directing filtered airflow toward a wearer in use, for example for directing filtered airflow emitted from the air outlet of the nozzle assembly. This may assist with directionality of filtered airflow in use. The flow guide may comprise a resiliently deformable material. This may ensure comfort of a wearer in the event of accidental contact of the flow guide with the face of a wearer in use.

According to a second aspect of the present invention there is provided a nozzle assembly for a wearable air purifier, the nozzle assembly comprising an inlet aperture for receiving a filtered airflow from an air purifier assembly, an air outlet for emitting the filtered airflow from the nozzle assembly, a first end section for connection to a headgear, a second end section for connection to a headgear, and a midsection connected to the first end section by a first hinge and connected to the second end section by a second hinge.

According to a third aspect of the present invention there is provided a wearable air delivery apparatus comprising: a headgear; and a nozzle assembly comprising an inlet aperture for receiving an airflow, an air outlet for emitting the airflow from the nozzle assembly, a first end section connected to the headgear, a second end section connected to the headgear, and a midsection connected to the first end section by a first hinge and connected to the second end section by a second hinge. The inlet aperture may be configured to receive a filtered airflow from an air purifier assembly.

Preferential features of aspects of the present invention may be equally applied to other aspects of the present invention, where appropriate.

### BRIEF DESCRIPTION OF THE DRAWINGS

Embodiments of the invention will now be described, by way of example only, with reference to the accompanying drawings, in which:

FIG. 1 is a schematic front view of a wearable air purifier according to the present invention;

FIG. 2 is a schematic rear underside view of the wearable air purifier of FIG. 1;

FIG. 3 is a cross-sectional view of the wearable air purifier of FIG. 1 with a nozzle assembly removed;

FIG. 4 is a schematic upper front view of the wearable air purifier of FIG. 1 with the nozzle assembly detached;

FIG. 5 is an upper view of a nozzle assembly according to the present invention in isolation;

FIG. 6a is an upper view of first and second end sections of the nozzle assembly of FIG. 5 in a first rotational orientation;

FIG. 6b is an upper view of first and second end sections of the nozzle assembly of FIG. 5 in a second rotational orientation;

FIG. 7a is a schematic view of a first embodiment of an end section of a nozzle assembly according to the present invention;

FIG. 7b is a schematic view of a second embodiment of an end section of a nozzle assembly according to the present invention;

FIG. 7c is a schematic exploded view of a third embodiment of an end section of a nozzle assembly according to the present invention;

FIG. 8 is a schematic side view of the wearable air purifier of FIG. 1 with the nozzle assembly in a first configuration; and

FIG. 9 is a schematic side view of the wearable air purifier of FIG. 1 with the nozzle assembly in a second configuration.

### DETAILED DESCRIPTION OF THE INVENTION

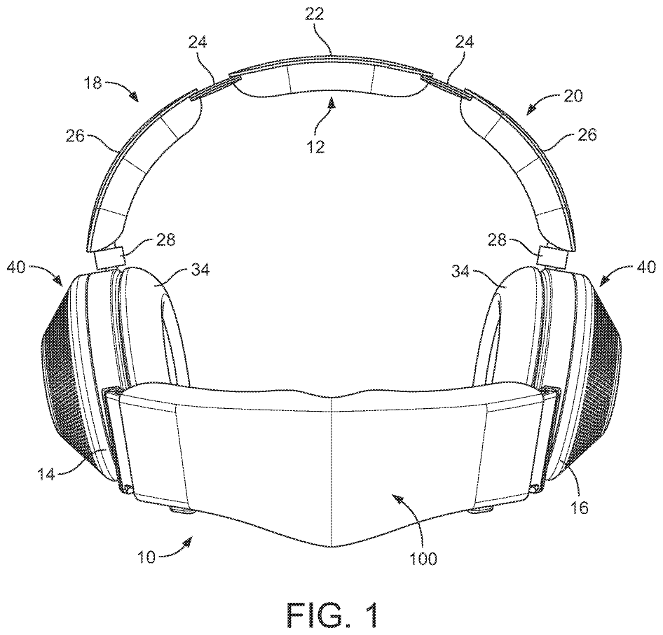

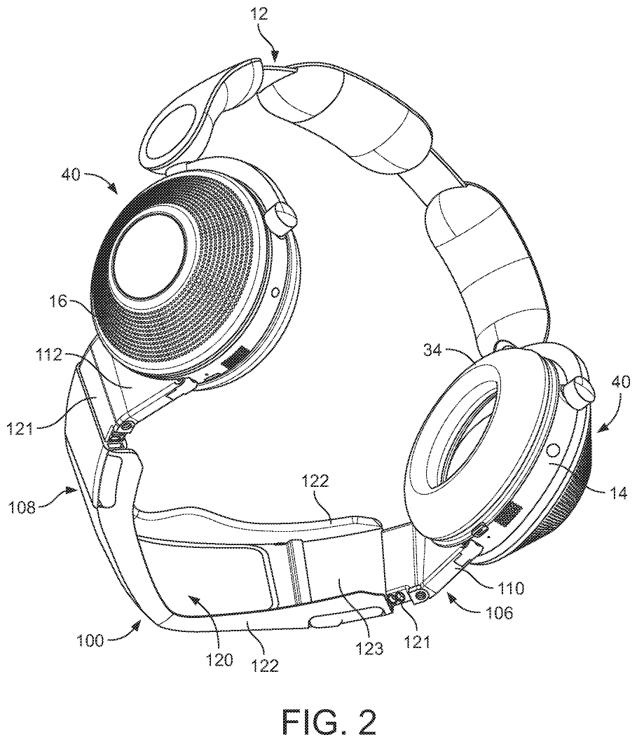

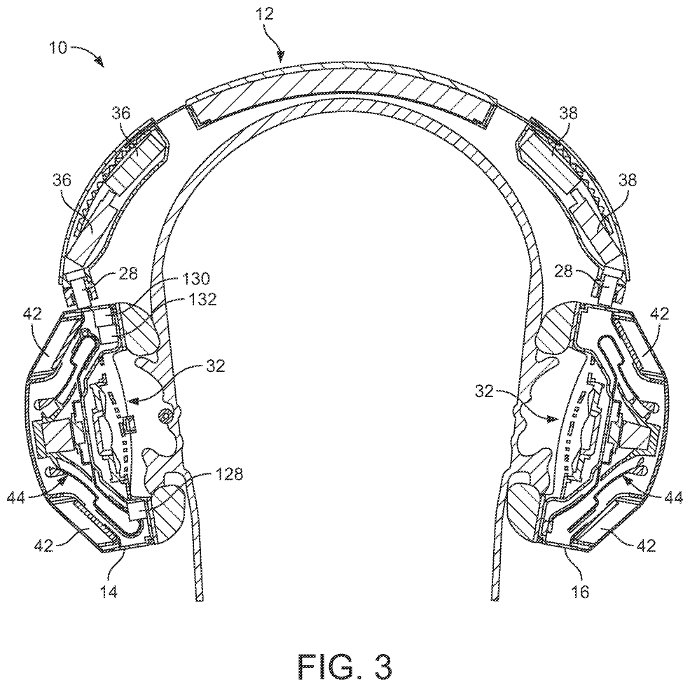

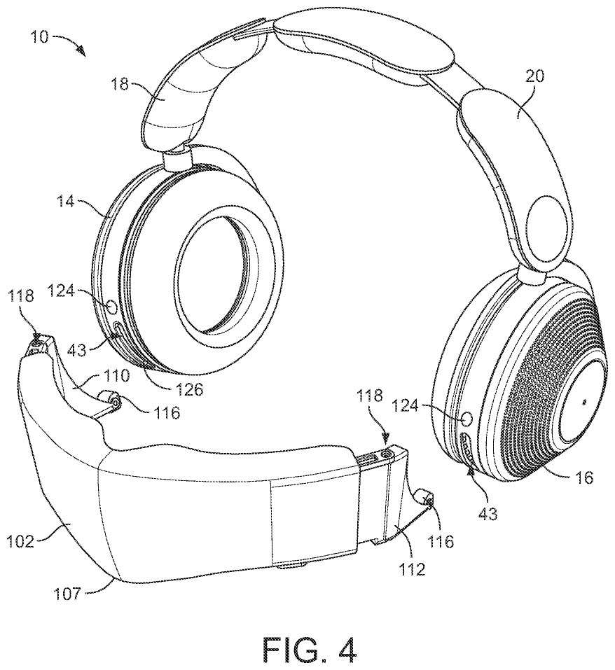

A wearable air purifier, generally designated 10, is shown schematically in FIGS. 1 and 2.

The wearable air purifier 10 comprises a headgear 12, 14 16, an purifier assembly 42,44, and a nozzle assembly 100.

The headgear has the form of headphones and comprises a headband 12 and first 14 and second 16 housings connected to respective ends of the headband 12. The headband 12 is generally elongate and arcuate in form, and is configured to overlie a top of a head of a wearer, and sides of the head of the wearer, in use. The first 14 and second 16 housings then comprise ear cups such as those typically used for so-called “over-the-ear” headphones, which are generally hemi-spherical and hollow in form.

The headband 12 has a first end portion 18, a second end portion 20, and a central portion 22. Each of the first 18 and second 20 end portions are connected to the central portion 22 by an extension mechanism. Each extension mechanism comprises an arm 24 that engages with teeth internal of the first 18 and second 20 end portions to form a ratchet mechanism that enables adjustment of the length of the headband 12 by a wearer. To this end, the teeth, a spacing between the teeth and an opposing wall, or the arm 24 itself, may be sufficiently resilient to provide the required retention.

The first 18 and second 20 end portions of the headband 12 each comprise a hollow housing 26. The hollow housing 26 defines a battery compartment for receiving one or more batteries therein. It will be appreciated that batteries may be removable from the hollow housing 26, or may be intended to be retained within the hollow housing 26 during normal use. Where the batteries are replaceable and intended to be removable from the hollow housing 26, the hollow housing 26 may, for example, comprise a releasable door or cover to enable access to the interior of the hollow housing 26. Where batteries are rechargeable and intended to be retained within the hollow housing 26 in normal use, the hollow housing 26, or indeed other components of the wearable air purifier 10, may comprise at least one charge port to enable recharging of batteries.

The first 18 and second 20 end portions of the headband 12 are connected to respective ones of the first 14 and second 16 housings. In some examples, the first 18 and second 20 end portions of the headband 12 are connected to respective ones of the first 14 and second 16 housings such that relative movement is enabled between the first 18 and second 20 end portions of the headband 12 and the respective first 14 and second 16 housings. As shown in FIG. 1, a swivel pin 28 is used for such a connection, but it will be appreciated by a person skilled in the art that other forms of connection are possible. To enable electrical connection of batteries contained within the hollow housings 26 of the first 18 and second 20 end portions of the headband 12 to components internal of the first 14 and second 16 housings, the swivel pins 28 are hollow, for example to allow electrical wiring or the like to pass therethrough.

Each housing 14,16 houses a speaker assembly 32, as shown in FIG. 3, and comprises annular padding 34 configured to surround an ear of a wearer of the wearable air purifier 10. Details of the speaker assembly 32 are not pertinent to the present invention, and so will not be described here for the sake of brevity, but it will be recognised by a person skilled in the art that any appropriate speaker assembly may be chosen. In use, the speaker assemblies 32 received within the first 14 and second 16 housings are configured to receive power from all of the batteries 36,38. Power transfer wiring (not shown) runs through the headband 12 between the first 18 and second 20 end portions, for example through the central portion 22 and arms 24. Such an arrangement provides increased flexibility in power distribution between the speaker assemblies 32. In other embodiments the speaker assemblies 32 received within the first 14 and second 16 housings may be configured to receive power from batteries 36,38 disposed in respective ones of the first 18 and second 20 end portions of the headband 12. For example, a speaker assembly 32 received within the first housing 14 may be configured to be powered by the batteries 36 within the first end portion 18 of the headband 12, whilst a speaker assembly 32 received within the second housing 16 may be configured to be powered by batteries 38 within the second end portion 20 of the headband 12.

As shown in FIG. 3, the first 14 and second 16 housings of the headgear further house filter assemblies 42 and airflow generators 44 of the air purifier assembly. Each housing 14,16 then also provides ambient air inlets 40 and outlet apertures 43 for the air purifier assembly.

The ambient air inlet 40 of each of the first 14 and second 16 housings comprises a plurality of apertures through which air may be drawn into the interior of the housing 14,16. Each filter assembly 42 is disposed within a respective housing 14,16 between the ambient air inlet 40 and a respective airflow generator 44. Each filter assembly 42 comprises a filter material chosen to provide a desired degree of filtration of air to be provided to a wearer in use.

The airflow generators 44 each comprise a motor driven impeller which draw air from the respective ambient air inlet 40, through the respective filter assembly 42, and output air through the respective outlet apertures 43, of the air purifier assembly that is provided by the respective housing 14,16. The airflow generators 44 in the first 14 and second 16 housings are configured to receive power from all of the batteries 36,38. Power transfer wiring (not shown) runs through the headband 12 as described above in relation to the speaker assemblies 32. In other embodiments, the airflow generator 44 within first housing 14 may be configured to be powered by batteries 36 within the first end portion 18 of the headband 12, whilst the airflow generator 44 in the second housing 16 may be configured to be powered by batteries 38 within the second end portion 20 of the headband 12.

The nozzle assembly 100 has first 106 and second 108 ends, and is curved between the first 106 and second 108 ends such that the nozzle assembly 100 is generally arcuate in form. The first 106 and second 108 ends comprise respective first 110 and second 112 end sections that connect to respective ones of the first 14 and second 16 housings of the headgear, as will be described in more detail hereafter, and that connect to a midsection 102 of the nozzle assembly by first and second hinges 104. When the nozzle assembly 100 is connected to the first 14 and second 16 housings, and the wearable air purifier 10 is worn by a wearer, the nozzle assembly 100 is configured to extend in front of the face of the wearer, particularly the mouth and lower nasal region of the wearer, without contacting the face of the wearer.

The midsection 102 is generally hollow in form, and has an air outlet 120 that is defined by a mesh.

Upper and lower surfaces of the midsection 102 comprise flow guides 122 that extend rearwardly, for example toward a void defined between the first 110 and second 112 end sections, and act to guide filtered airflow emitted from the nozzle assembly 100 toward a mouth and nasal region of a face of a wearer in use. The flow guides 122 may be formed of a resiliently deformable material to allow for some deformation of the midsection and such that wearer comfort is provided in the event of accidental contact with a face of a wearer in use.

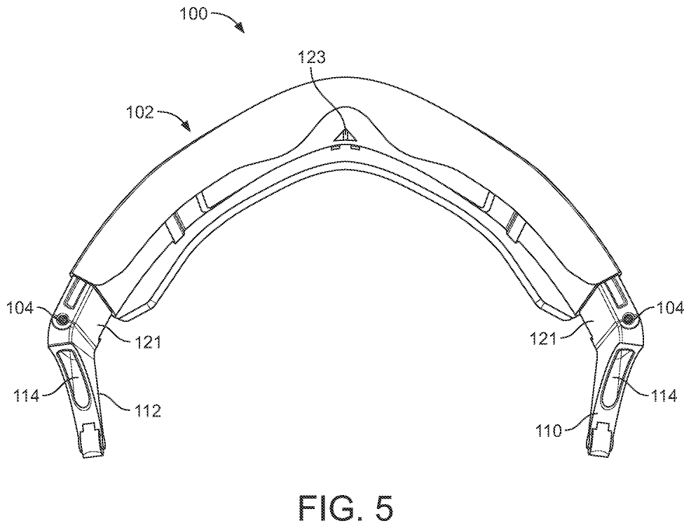

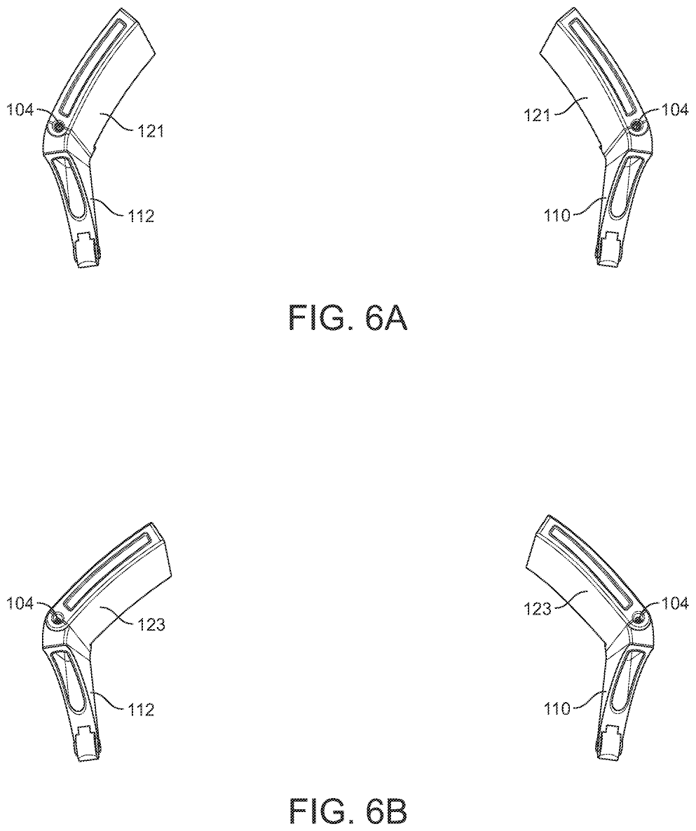

As shown in FIGS. 2 and 5, the midsection 102 includes a main body 123 having a first end and a second end, and extension mechanisms 121 that connect the first end and second end of main body 123 to the respective first and second hinges 104. The extension mechanisms 121 may take many forms, and may, for example, comprise a telescoping and/or ratchet mechanism that enables a length of the nozzle assembly 100 to be selectively increased or decreased by a wearer. The extension mechanisms 121 are hollow, and act as conduits to carry filtered airflow from the first 110 and second 112 end sections to the main body 123 of the midsection 102 in use. The first and second hinges 104 allow rotation of the midsection 102 relative to the first 110 and second 112 end sections. The midsection 102 also has a central crease or ridge 107, which may allow for some deformation of the midsection to allow for greater conformability of the nozzle assembly 100 and to accommodate motion of the nozzle assembly 100. Such an arrangement may provide flexibility in the positioning of the midsection 102, and hence the air outlet 120, relative to a face of the wearer in use, and hence may provide greater conformability and increased comfort.

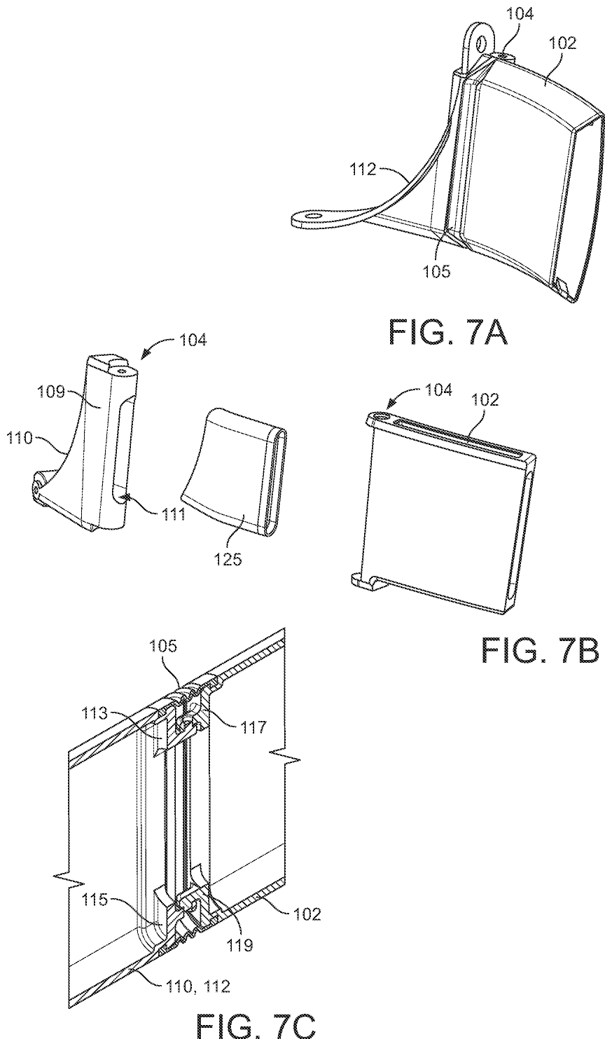

Examples of alternative embodiments where the midsection 102 is rotatably connected to the first 110 and second 112 end sections by respective first and second hinges 104 are shown in FIGS. 7a-c.

In the embodiment of FIG. 7a, the second end section 112 is shown connected to the midsection 102 by both a hinge 104 and a bellows portion 105. The hinge 104 allows rotation of the midsection 102 relative to the second end section 112, whilst the bellows portion 105 is formed of a relatively flexible material, and is able to expand and contract in response to rotation about the hinge 104. The bellows portion 105 defines a conduit that enables the passage of filtered airflow from the second end section 112 to the midsection 102, whilst the hinge 104 is located externally of the bellows portion 105, such that the hinge 104 is not in contact with filtered airflow flowing through the nozzle assembly 100 in use.

In the embodiment of FIG. 7b, the first end section 110 is shown connected to the midsection 102 by a hinge 104. Here the first end section 110 defines a barrel or cylinder 109, and the midsection 102 comprises upper and lower pins (not shown) which are received within respective upper and lower apertures of the barrel 109. The barrel 109 has a slot 111 through which filtered airflow is able to pass from the first end section 110 to the midsection 102 in use. A flexible tube 125 is located within the slot 111, and projects into a hollow interior of the midsection 102. The flexible tube 125 is sealed to interior walls of the slot 111 and closely fitted to interior walls of the midsection 102 to minimise the leakage of air passing through the hinge 104.

In the embodiment of FIG. 7c, the second end section 110, 112 is shown connected to the midsection 102 by both a hinge 104 and a bellows portion 105. Here the end section 110,112 has upper 113 and lower 115 arms that engage with corresponding upper 117 and lower 119 arms of the midsection to enable relative rotation between the end section 110,112 and the midsection 102. The bellows portion 105 surrounds the interface between the arms 113,115,117,119, and the bellows portion 105 is formed of a relatively flexible material that is able to expand and contract to account for relative rotation between the end section 110,112 and the midsection 102. The bellows portion 105 defines a conduit that enables the passage of filtered airflow from the end section 110,112 to the midsection 102.

As previously mentioned, the first 110 and second 112 end sections connect to respective ones of the first 14 and second 16 housings to connect the nozzle assembly 100 to the first 14 and second 16 housings of the headgear. The first 14 and second 16 housings connect to the first 18 and second 20 end portions of the headband 12. Thus the nozzle assembly 100 is directly connected to the headgear 10. It will also be appreciated that in some embodiments the nozzle assembly 100 may be directly connected to other components of the wearable air purifier that are supported by the headgear. The nozzle assembly 100 may then be thought of as being indirectly connected to the headgear 10.

In a first configuration, the first 110 and second 112 end sections act as conduits to carry filtered airflow from the airflow generator 44 in the first 14 and second 16 housing respectively to the midsection 102 in use. To this end, the end sections 110,112 have curved ends which are curved to match an outer surface of the first 14 and second 16 housings. The first 110 and second 112 end sections are generally hollow and have inlet apertures 114 which are configured to be in direct fluid communication with outlet apertures 43 of the air purifier assembly, which are provided by the first 14 and second 16 housings, when the nozzle assembly 100 is connected to the first 14 and second 16 housings respectively and in the first configuration. For example, there may be no components intermediate the outlet apertures 43 and the inlet apertures 114 in the first configuration.

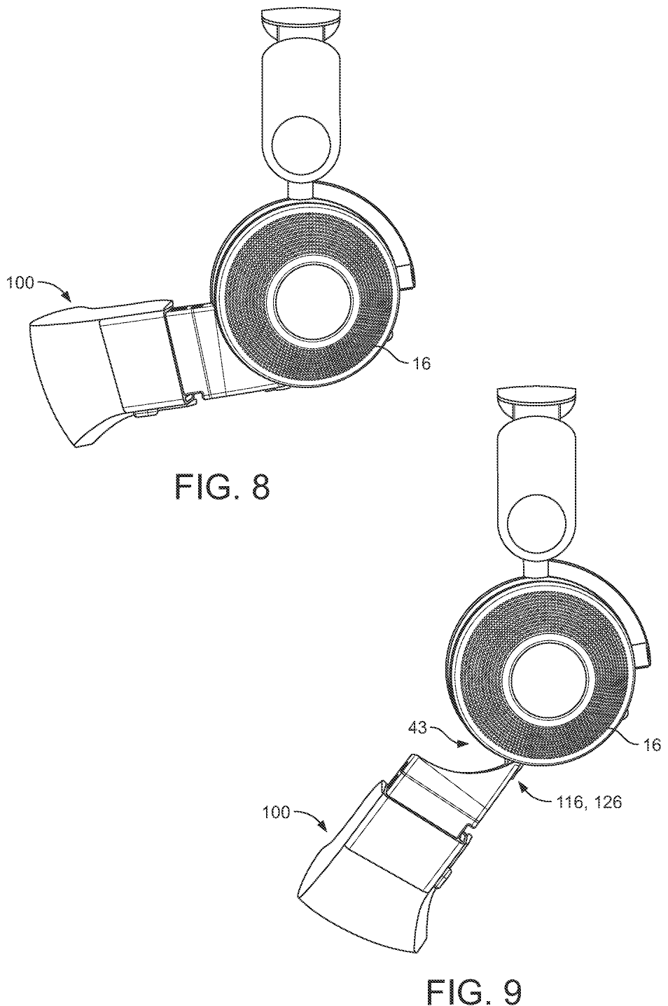

The end sections 110,112 comprise magnetic hinges 116 and magnetic detents 118 which respectively rotatably connect and retain the midsection 102 relative to the first 14 and second 16 housings. To this end, each of the first 14 and second 16 housings comprise respective upper 124 and lower 126 magnets, with the upper magnets 124 located to engage the magnetic detents 118, and the lower magnets 126 located to engage the magnetic hinges 116. As is clear from FIGS. 8 and 9 the magnetic hinges 116 enable the nozzle assembly 100 to rotate relative to the first 14 and second 16 housings. In particular, the nozzle assembly 100 is rotatable about the magnetic hinges 116 between a first configuration, shown in FIG. 8, and a second configuration, shown in FIG. 9.

In the first configuration of FIG. 8, the nozzle assembly 100 is fully connected to the first 14 and second 16 housings and is held in place by the engagement of the upper magnets 124 with the magnetic detents 118 and the magnetic hinges 116 with the lower magnets 126. The inlet apertures 114 of the first 110 and second 112 end sections of the midsection 102 are substantially aligned with, and coincident with, the outlet apertures 43 provided by the respective first 14 and second 16 housings. When filtered airflow is provided by the airflow generators, it is able to pass through the outlet apertures 43, into the inlet apertures 114, and then flow through the midsection 102 to the air outlet 120 where it is provided to the wearer.

In use, in the first configuration, the wearable air purifier 10 is located on a head of a wearer such that the first 14 and second 16 housings are located over an ear of the wearer, and the nozzle assembly 100 extends in front of a mouth and lower nasal region of the face of the wearer, without contacting the face of the wearer. The airflow generators 44 are actuable to draw air through the ambient air inlet 40 provided by each of the first 14 and second 16 housings, through the filter assemblies 42, and expel filtered airflow through the outlet apertures 43 into the inlet apertures 114 of the first 110 and second 112 end sections of the midsection 102. Filtered airflow travels through the midsection 102 as first and second filtered airflows, and is delivered from the nozzle assembly 100, via the air outlet 120, to the wearer of the wearable air purifier 10. The speaker assemblies 32 may provide audio data to a user, for example in the form of music and the like, and alternatively or additionally may provide noise cancellation for noise caused by operation of the airflow generators 44.

Although depicted here with two airflow generators 44, each feeding one end of the nozzle assembly 100, it will be appreciated that in alternative embodiments only a single airflow generator 44 may be provided, which may either feed both or one of the ends of the nozzle assembly 100.

When it is desired to move the nozzle assembly from the first configuration of FIG. 8 to the second configuration of FIG. 9, a wearer can manually rotate the nozzle assembly about the magnetic hinges 116, against and overcoming the force of attraction between the magnetic detents 118 and the upper magnets 124, such that the nozzle assembly 100 rotates downwardly relative to the wearer (i.e. in a plane parallel to a sagittal plane of a wearer), thereby increasing the angle between the nozzle assembly 100 and the first 14 and second 16 housings of the headgear. In the second configuration of FIG. 9, the nozzle assembly 100 is only partially connected to the first 14 and second 16 housings with the inlet apertures 114 spaced apart from, and misaligned with, the outlet apertures 43, such that no filtered airflow passes through the midsection 102 to the wearer.

In some embodiments, a sensor 128, an airflow generator controller 130, and a speaker assembly controller 132 are provided in at least one of the first 14 and second 16 housings (shown schematically in the first purifier assembly housing 14 in FIG. 3). For example, the sensor 128 may be a Hall sensor that is configured to sense the magnetic detent 118 of an end section 110, 112 of the nozzle assembly 100. As an alternative example, the sensor 128 may be a contract switch that is closed when an end section 110,112 of the nozzle assembly 100 is fully connected to the respective housing 14,16. When the sensor 128 detects movement of an end section 110,112 away from the respective housing 14,16, the sensor 128 communicates with the airflow generator controller 130 which controls both airflow generators 44 to stop the generation of airflow. This may provide power saving by preventing operation of the airflow generators 44 when the nozzle assembly 100 is not in a position to provide filtered airflow to the wearer, i.e. when the nozzle assembly 100 is in the second configuration. Furthermore, when the sensor 128 detects movement of an end section 110,112 away from the respective housing 14,16, the sensor 128 communicates with the speaker assembly controller 132 which controls both speaker assemblies 32 to pause or stop generation of audio content and/or noise/cancellation effects. Again, this may provide a power saving by inhibiting operation of the speaker assemblies 32 when the nozzle assembly 100 is in the second configuration, for example dipped when a wearer intends to talk.

Although shown here as having a single sensor 128, it will be appreciated that two sensors 128 may be provided, one for each end of the nozzle assembly 100. It will further be appreciated that the sensor data may cause the controllers 130,132 to control operation of one or more of the respective airflow generators 44 and speaker assemblies 32. The airflow generator controller 130 may automatically control the airflow generators 44 in response to detection of the first configuration of the nozzle assembly, or a user input may be required to start airflow generation.

It will further be appreciated that appropriate wired and/or wireless communications may be provided between the sensor 128 and the controllers 130,132, or between the controllers 130,132 and the airflow generators 44 and speaker assemblies 32, and that any appropriate form of sensor 128 that is capable of detecting whether the nozzle assembly 100 is in the first or second configurations may be utilised.

The connection between the nozzle assembly 100 and the housings 14,16 is provided by hinges such that the nozzle assembly 100 is rotatable relative to the housings 14,16, and it will be appreciated that any hinged connection may be provided. In embodiments described herein, the hinges are magnetic hinges 116, which are fixedly attached to the end sections 110,112 of the nozzle assembly 100 and releasably attached to the respective first 14 and second 16 housings via the lower magnets 126. Such a releasable connection may allow for complete removal of the nozzle assembly 100 from the first 14 and second 16 housings, which may allow for ease of cleaning of the nozzle assembly 100 and may allow for head wearable air purifier to be used as conventional headphones when the wearer does not require a supply of filtered air.

It will be appreciated that the strength of attachment between the magnetic hinges 116 and the lower magnets 126 may be greater than the strength of attachment between the magnetic detents 118 and the upper magnets 124, such that rotation about the magnetic hinges 116 is enabled without inadvertent removal of the nozzle assembly 100 in use.

In the embodiments described herein the magnetic attachments between the nozzle assembly 100 and the housings 14,16 of headgear are achieved through cooperation between magnets 118,140 provided on the end sections 110,112 of the nozzle assembly 100 and magnets provided on the housings 14,16. However it will be appreciated that in alternative embodiments the magnetic attachments between the nozzle assembly 100 and the housings 14,16 of headgear may be achieved through cooperation of magnets (i.e. permanent magnets) provided on one or other of the end sections 110,112 and the housings 14,16 and magnetic material (i.e. that is magnetically attracted to a magnet) provided on the other of the end sections 110,112 and the housings 14,16.

Furthermore, in the illustrated embodiments the filter assemblies 42 and airflow generators 44 of the air purifier assembly are housed within the housings 14,16 of the headgear (i.e. that form the earcups), and are therefore integral/built-in to the headgear such that the ambient air inlets 40 and outlet apertures 43 of the air purifier assembly are provided by these housing 14,16. However, it will be appreciated that in some embodiments the filter assemblies 42 and airflow generators 44 of the air purifier assembly may be housed within their own distinct purifier assembly housings, with the ambient air inlets and outlet apertures of the air purifier assembly then being provided by these purifier assembly housings.

In such embodiments, the purifier assembly housings then may or may not be supported by the headgear. For purifier assembly housings that are supported by the headgear, the nozzle assembly may be directly connected to the outlet apertures of the air purifier assembly, such that the nozzle assembly is indirectly connected to the headgear. Alternatively, the nozzle assembly may be directly connected to the headgear and fluidically connected to the outlet apertures of the air purifier assembly by ducting that is connected to the headgear. For purifier assembly housings that are not supported by the headgear, and are instead worn elsewhere on the body of wearer (e.g. on a belt or around the neck of the wearer), the nozzle assembly may be directly connected to the headgear and fluidically connected to the outlet apertures of the air purifier assembly by ducting that is connected to the headgear.

1. A wearable air purifier comprising:
a headgear;
an air purifier assembly, the air purifier assembly comprising a filter and an airflow generator for generating an airflow through the filter; and
a nozzle assembly comprising an inlet aperture for receiving a filtered airflow from the air purifier assembly, and an air outlet for emitting the filtered airflow from the nozzle assembly;
wherein the nozzle assembly comprises a first end section connected to the headgear, a second end section connected to the headgear, and a midsection connected to the first end section by a first hinge and connected to the second end section by a second hinge.

2. The wearable air purifier as claimed in claim 1, wherein the air purifier assembly is supported by the headgear.

3. The wearable air purifier as claimed in claim 1, wherein the first end section is connected to a first side of the headgear, and the second end section is connected to a second side of the headgear, the second side opposite to the first side.

4. The wearable air purifier as claimed in claim 1, wherein the first and second hinges allow rotation of the midsection relative to the respective first and second end sections in a plane parallel to a transverse plane of a wearer of the headgear in use.

5. The wearable air purifier as claimed in claim 1, wherein the first end section and the midsection each comprise a hollow body, the first end section defines at least a portion of the inlet aperture of the nozzle assembly and the midsection defines at least a portion the air outlet of the nozzle assembly.

6. The wearable air purifier as claimed in claim 1, wherein the second end section comprises a hollow body, and the second end section defines at least a portion of a further inlet aperture of the nozzle assembly.

7. The wearable air purifier as claimed in claim 1, wherein at least one of the first and second hinges is located outside of filtered airflow through the nozzle assembly in use.

8. The wearable air purifier as claimed in claim 1, where at least one of the first and second hinges comprises a pin received within a barrel, and the barrel comprises a slot through which filtered airflow passes in use.

9. The wearable air purifier as claimed in claim 8, wherein a flexible duct extends through the slot of the barrel, and filtered airflow flows through the flexible duct in use.

10. The wearable air purifier as claimed in claim 1, wherein the nozzle assembly comprises a first bellows portion extending between the first end section and the midsection, and a second bellows portion extending between the second end section and the midsection.

11. The wearable air purifier as claimed in claim 1, wherein the nozzle assembly comprises at least one extension mechanism for increasing a length of the nozzle assembly.

12. The wearable air purifier as claimed in claim 1, wherein the midsection comprises at least one extension mechanism for increasing a length of the nozzle assembly.

13. The wearable air purifier as claimed in claim 1, wherein at least one of the first and second end sections comprises an extension mechanism for increasing a length of the nozzle assembly.

14. The wearable air purifier as claimed in claim 1, wherein the midsection comprises at least one crease about which portions of the midsection can flex relative to one another in use.

15. The wearable air purifier as claimed in claim 1, wherein the airflow generator and filter are configured to provide filtered airflow to the first end section of the nozzle assembly in use.

16. The wearable air purifier as claimed in claim 1, wherein the air purifier assembly comprises a further airflow generator and a further filter configured to provide a further filtered airflow to the second end section of the nozzle assembly in use.

17. The wearable air purifier as claimed in claim 1, wherein the first end section is at least partially connected to the headgear by a third hinge, and the second end section is at least partially connected to the headgear by a fourth hinge.

18. The wearable air purifier as claimed in claim 1, wherein the nozzle assembly comprises at least one flow guide for directing filtered airflow toward a wearer in use.

19. A nozzle assembly for a wearable air purifier, the nozzle assembly comprising an inlet aperture for receiving a filtered airflow from an air purifier assembly, an air outlet for emitting the filtered airflow from the nozzle assembly, a first end section for connection to a headgear, a second end section for connection to a headgear, and a midsection connected to the first end section by a first hinge and connected to the second end section by a second hinge.
